(19) United States
(12) Patent Application Publication
(10) Pub. No.: US 2012/0178435 A1
(43) Pub. Date: Jul. 12, 2012

(54) SYSTEM AND METHOD FOR PERPOSTEROUS CELLULAR BLACK BOX APPLICATIONS

(76) Inventor: Benjamin Charles Levitan, (US)

(21) Appl. No.: 12/972,948

(22) Filed: Jan. 9, 2011

(51) Int. Cl. H04W 40/02

(52) U.S. Cl. 455/422.1

(57) ABSTRACT

A system and method for setting up a call between an originator and a destination are disclosed. A request for an interconnect call is sent to a push-to-talk (PTT) location register. The PTT location register determines whether the destination is currently available. If it is determined that the destination is not currently available, a call failure message to sent to the originator. If it is determined that the destination is available, then a PTT call is setup between the originator and destination. An interconnect call is then setup between the source and destination and the PTT call is torn down.

The invention defines systems and methods of storing cellular telephone technical data for a period of time for the purpose of data mining of pre-determined time periods. The invention provides systems and methods useful in analyzing the movements of people or the technical behavior of the system itself.

In one embodiment, cellular base stations in a mobile phone system, store the autonomous registration of all registration that are phones that are perform registrations rather than discarding the data, as is the industry practice since the storage of such information is voluminous and of little technical value. The embodiment described stores data for a period of twenty four hours to assist law enforcement in criminal investigations. When a crime occurs within the coverage area of the cellular system, all activity (all phone registration that occurred in the in the area) can be useful to assist law enforcement in determining potential suspects, witnesses and locations of subjects associated with a specific incident.

In the case of a serial offender, this system may quickly discover a single mobile device that appears in the system during each event thus filtering the range of suspects to a single mobile device owner. Further, the perpetrator may be tracked to and from the crime through the use of stored technical data in other base stations that may be collected during intra-system handoffs or autonomous registrations.

The system is similar in nature to “black boxes” used in the aviation industry to determine the reason for aviation accidents. A recording device with in an aircraft records the last 30 minutes cockpit conversation and instrument data of a flight prior to the accident. This is realized by using a thirty minute recording loop. In the event of an accident, the tape halts and technical information plus cockpit recording information for the final thirty minutes of the flight is recorded and can be analyzed for the cause of the accident.

The invention described in this first embodiment operates in a similar manner, collecting the mobile directory numbers of cellular phones active within each base station. Should there be no requests for information, the system simply overwrites the oldest information and continues to store a 24 hour period of data. Should a crime occur, law enforcement is able to request all data for the hours before and after the event in order to use in determining the location of potential perpetrators, victims and witnesses.

### BACKGROUND OF THE INVENTION

Studies show that approximately 80% of calls fail to reach the called party. Call failure is due to a variety of different factors such as network failure, the calling party is busy, the calling party does not answer, etc. Because communication carriers do not realize revenue for setting up calls or failed calls, it is desirable to minimize the cost of call setup. Additionally, it would be desirable to callers to quickly determine whether a called party is available.

FIG. 1 illustrates a conventional method for a successful call setup. A calling party dials a called party number. The dialed digits are sent to a local exchange carrier (LEC) (step 1). The LEC routes the call to the public switched telephone network (PSTN) (step 2). The call request is routed through the PSTN to a mobile switch (step 3). Voice circuits are reserved for the call from the source and destination ends of the call in case the called party is available and ready to take the call.

The mobile switch requests the last known location of the called party from a home location register (HLR) (step 4). The HLR returns the location information (step 5). This location information does not indicate whether the called party is currently active. The mobile switch forwards the call request to a base station associated with the called party's location. The base station transmits a paging message (step 6). If the called party is at the last known location, then the called party's phone responds to the page, changes to the channels directed by the paging message to prepare to receive the call, and starts to ring for the called party (step 7). The call is then cut through to the called party (step 8).

FIG. 2 illustrates a conventional method for call setup failure. Steps 1-5 operate in a similar manner to that described above in connection with FIG. 1, the differences occur after the paging message is sent to the last known location of the called party. If the called party's mobile station does not respond to the paging message transmitted from the base station after a predetermined amount of time, the call times out (step 6). The HLR will mark the called party's record to indicate that the called party is not available (step 7). This will increase the speed of the next call failure, but will create a long delay for the current call failure. If the called party re-registers with the HLR, the process returns to normal. An announcement is returned to the calling party that the called party is unavailable. (step 8).

The call failure described in connection with FIG. 2 will generate no revenue for the network operator. However, the call failure produces costs to the network operator, especially if the operator is using a signaling system 7 (SS7) network from a third party provider. Moreover, it may take 10 seconds or more for the calling party to be notified that the called party is not available.

### SUMMARY OF THE INVENTION

In accordance with exemplary embodiments of the present invention, a push-to-talk (PTT) network (also known as a dispatch network) is used to determine if the called party is available. If the called party is not available, the call fails with only a small expenditure of network resources. If the called party is available, information as to the status of the called party is immediately available to determine if the call should be setup or should be postponed for a later time. If the call is completed, the call will start on the PTT network and then be transitioned to a circuit switched network.

### BRIEF DESCRIPTION OF THE DRAWING FIGURES

FIG. 1 illustrates a conventional method for a successful call setup;

FIG. 2 illustrates a conventional method for a call setup failure;

FIG. 3 illustrates an exemplary method for a call setup failure in accordance with the present invention; and

FIG. 4 illustrates an exemplary method for a successful call setup in accordance with the present invention.

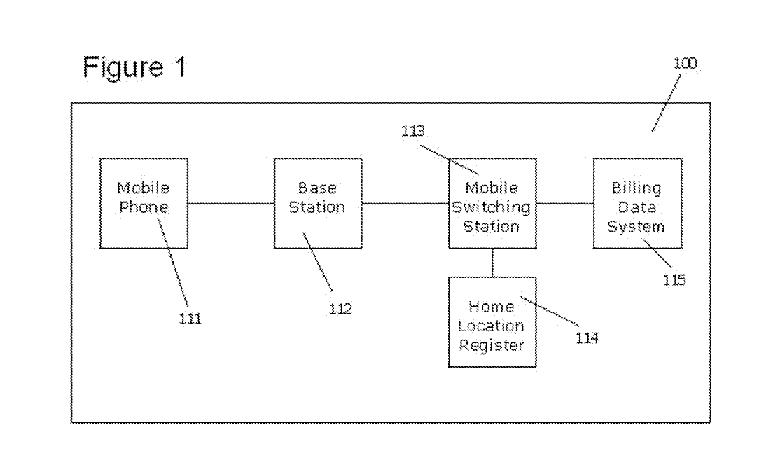

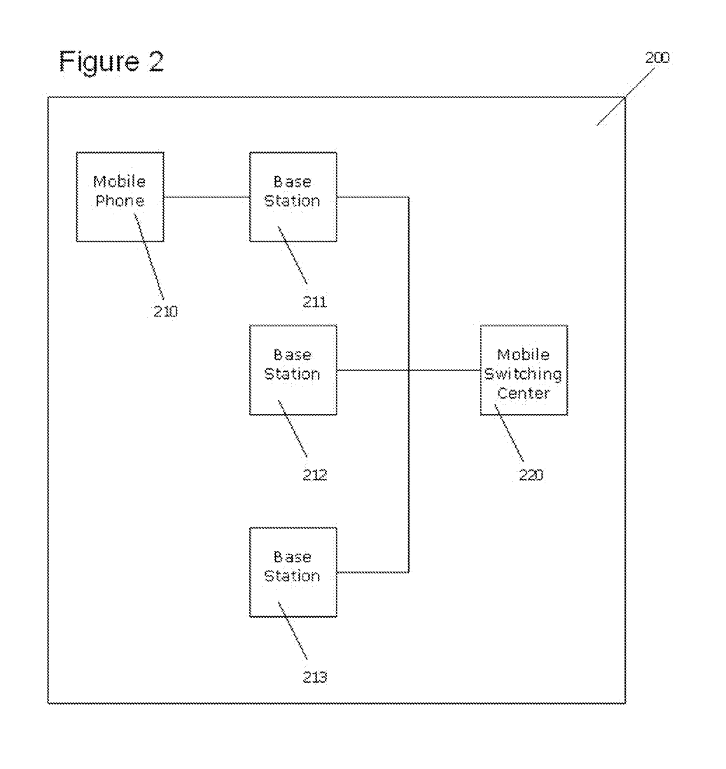

### DETAILED DESCRIPTION OF THE PREFERRED EMBODIMENTS

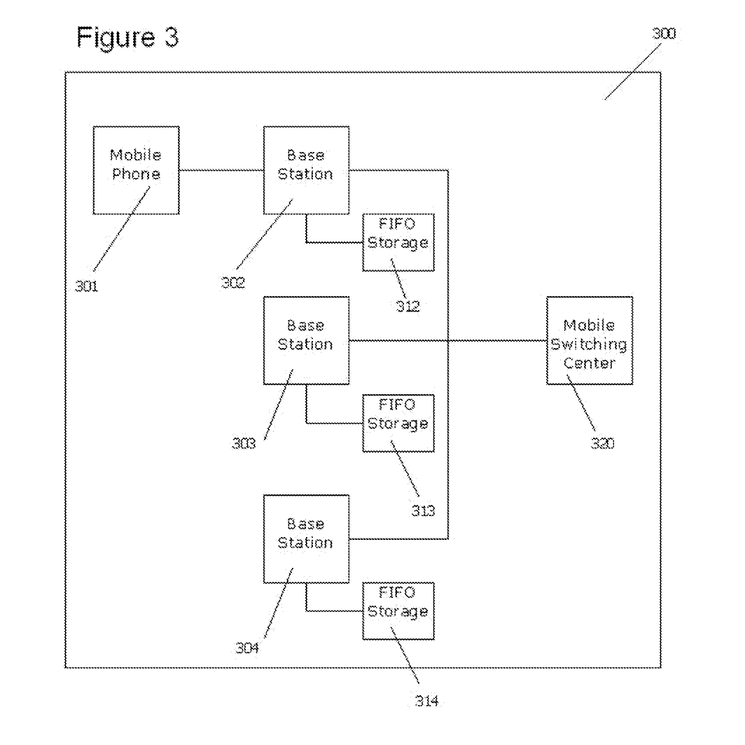

Exemplary embodiments of the present invention leverage a PTT network to increase the speed of call setups, and call setup failures, for interconnect calls. One such network which includes both a PTT network and an interconnect network is the iDEN network, such as that owned and operated by Nextel Communications Inc. of Reston, Va. FIG. 3 illustrates an exemplary method for call setup failure in accordance with the present invention. In the iDEN network mobile stations are registered in both the PTT HLR and the interconnect HLR (step 1). This registration in the PTT HLR indicates that the registered mobile station is available and ready to receive calls. If the registration for the mobile station in the PTT HLR is marked as not available and a PTT call is attempted to the party, the network provides an immediate “Call Fail” message to the calling party.

In accordance with exemplary embodiments of the present invention, when an interconnect call is placed from a user registered in the PTT HLR to another iDEN subscriber, the mobile station transmits the PTT urban, fleet, mobile identifier (UFMI) to the PTT HLR (step 2). The UFMI is typically used only for PTT calls and not for interconnect calls. Accordingly, the mobile station is programmed to send the UFMI to a PTT HLR (instead of a personal telephone number (PTN) to the interconnect HLR), and the mobile station will set the call as an interconnect call. The network is programmed to accept UFMIs and route the call request to the PTT HLR for interconnect call setups, and the network marks the call setup, which appears as a PTT call setup, as a pending interconnect call. If the called party is not registered as available in the PTT HLR, there is an immediate failure response returned to the call party's mobile station (step 4). Because the mobile station set the call as an interconnect call, the mobile station will display an indication of “party not available.”

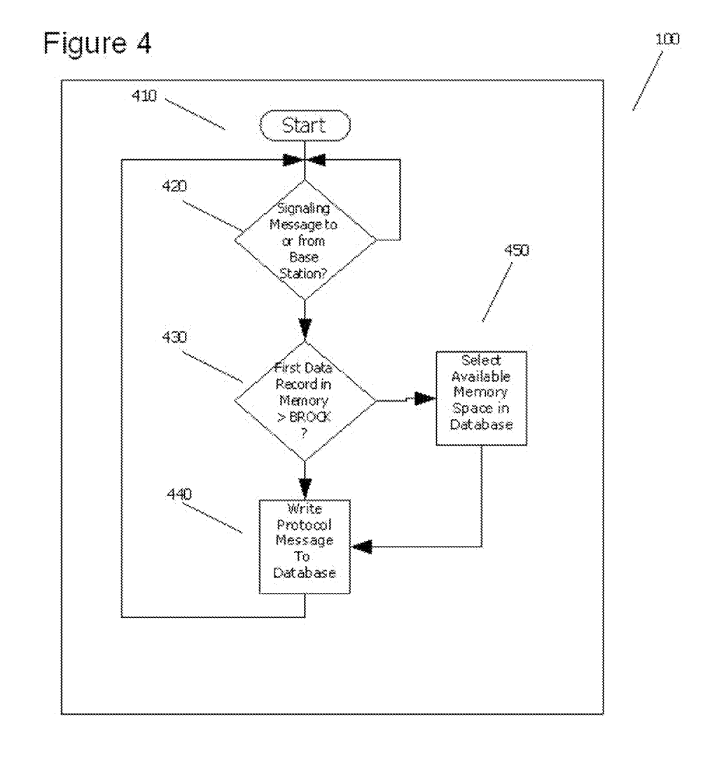

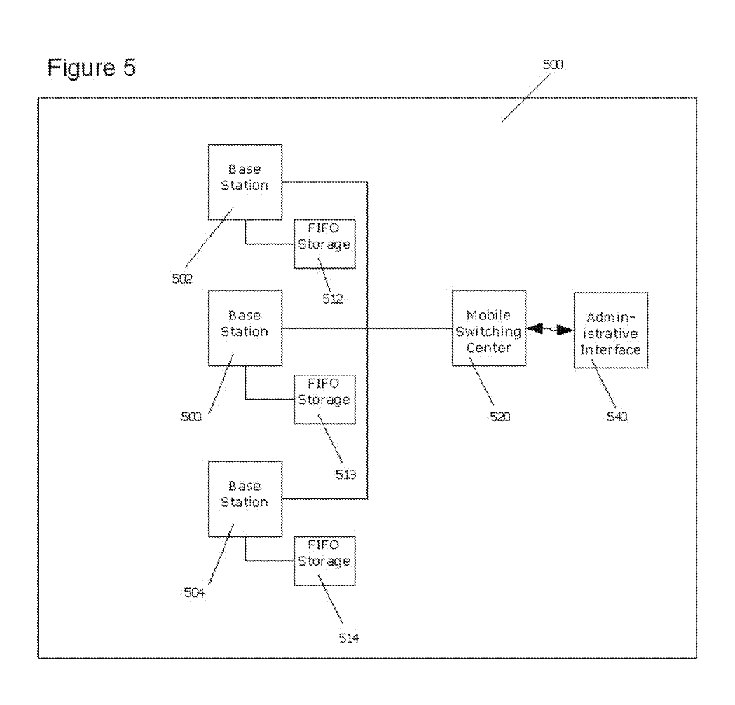

FIG. 4 illustrates an exemplary method for a successful call setup in accordance with the present invention. Steps 1 and 2 operate as discussed above in connection with FIG. 3. However, in the method illustrated in FIG. 4, the called party is registered in the PTT HLR as available. Accordingly, the PTT HLR returns a call success message (step 3). The call request is forwarded to a PTT server, such as a dispatch application processor (DAP) with an interconnect call indication (step 4). This causes a PTT alert to be transmitted to a switch, such as a metro packet switch (MPS).

The switch forwards an indication of a PTT call with an interconnect call indication to the mobile station (step 5). This causes the called party's mobile station to ring as in a conventional interconnect call. The called party's mobile station also receives the calling party's name or caller ID. When the called party answers the call, the ringing is stopped and a PTT response is launched to the calling party (step 6). The PTT response is an “Answer” message which opens a one-way circuit (simplex) allowing the calling party to hear the called party.

When the “Answer” message is launched from the called party, a standard SS7 call setup is launched from the calling party's system to the called party (step 7). The call is connected without an alert and ringing to the called party, and the interconnect call is established (step 8). Because the interconnect call is setup, the PTT call is released and the interconnect call is established by paging the mobile station that is in a temporary idle mode awaiting channel assignment. There will be no ringing or page response required from the mobile station because the called mobile station is known to be available. The channel assignment is simply accepted and the mobile station moves from idle mode to “on channel” mode. The calling and called party are now on an interconnect call, and any subsequent call attempts to the parties will result in an “immediate call failure” as in the method of FIG. 3 because both parties are currently on a call.

The type of information provided upon a call setup failure described above in connection with FIG. 3 can include various types of information. Specifically, the PTT HLR can track a variety of states to enable more information to be provided upon call setup failure. When an interconnect call is setup for a mobile station, a record in the PTT HLR is marked as “on a call” for both parties. Additionally, when a mobile station is not located in their home system and is not registered with the PTT HLR, an “Out of Area” response can be returned to the calling party. Moreover, if a mobile station is active in a PTT call, the PTT HLR will mark the mobile station as “On a PTT session” and return such an indication to the calling party.

The present invention allows a caller to be notified that a called party is unavailable by using the less resource intensive technique of setting up a call over the PTT network, compared to more resource intensive conventional technique of setting up a call over the interconnect network. Additionally, the present invention's use of the PTT network is less costly than employing an SS7 network. Moreover, the caller is notified much quicker that a called party is unavailable.

Although exemplary embodiments of the present invention have been described above in connection with an iDEN network, it will be recognized that the present invention can be used in a variety of different types of networks. For example, in the iDEN network interconnect calls are handled in a similar manner to circuit-switched calls in the PSTN, while PTT calls are routed through a data network. Accordingly, the present invention is applicable to any network which employs a second type of network with a location register which tracks whether callers are currently available.

While the invention has been described in connection with various embodiments, it will be understood that the invention is capable of further modifications. This application is intended to cover any variations, uses or adaptations of the invention following, in general, the principles of the invention, and including such departures from the present disclosure as known, within the known and customary practice within the art to which the invention pertains.

What is claimed is:

1. A method for setting up an interconnect call, the method comprising the acts of:
sending a call setup request to a dispatch location register;
determining, by the dispatch location register, whether a destination associated with the call setup request is currently available;
returning, from the dispatch location register, a call failure message when the destination is not currently available; and
completing the interconnect call when the destination is currently available.

2. The method of claim 1, wherein the act of completing the interconnect call comprises the acts of:
establishing a dispatch call between an originator of the call setup request and the destination;
establishing an interconnect call between the originator and the destination; and
tearing down the dispatch call after the interconnect call has been established.

3. The method of claim 1, wherein the call failure message indicates whether the destination is on a call, out of area or on a dispatch call.
